(19) United States
(12) Patent Application Publication
(10) Pub. No.: US 2010/0206876 A1
(43) Pub. Date: Aug. 19, 2010

(54) METHOD FOR PRODUCING A THIN-WALLED LARGE-VOLUME CONTAINER, RESULTING CONTAINER AND DEVICE FOR RECEIVING AND COMMISSIONING SAID CONTAINER

(75) Inventor: Jean-Tristan Outreman, Saint Maximin La Sainte Baume (FR)

Correspondence Address: YOUNG & THOMPSON, 209 Madison Street, Suite 500, Alexandria, VA, 22314, US

(73) Assignee: TECSOR S.A.S., Meyreuil (FR)

(21) Appl. No.: 12/682,609

(22) PCT Filed: Oct. 9, 2008
(86) PCT No.: PCT/FR08/51827

§ 371 Date: Apr. 12, 2010

(30) Foreign Application Priority Data
Oct. 10, 2007 (FR) 0758182

(51) Int. Cl. B65D 17/42; B29D 22/00

(52) U.S. Cl. 220/277; 264/572; 220/737

(57) ABSTRACT

A process for manufacturing a thin-walled, high-capacity container of more than 2 liters, includes the following stages:
Hot-shaping or cold-shaping to a desired volume a preformed shape that has a collar and a neck designed to receive a plug, whereby this preformed shape is able to exhibit residual stresses after its shaping to the desired volume,
Using a material weight/developed surface ratio for the container ranging between 150 g/m² and 250 g/m², and more particularly between 150 g/m² and 200 g/m². The container and the device for receiving this container are described.

This invention relates to a process for manufacturing a thin-walled, high-capacity container, and the container that is obtained.

The invention also covers a device for receiving and servicing this thin-walled container.

In the mineral water field, the distribution of individual bottles, generally with maximum capacities of 2 liters, exists. Actually, moreover, the weight makes handling difficult. Likewise, the transport of 6-bottle packs leads to a maximum weight for packaging under a retractable film to which is connected a handle that consists of an attached strip.

A demand for larger capacities has been noted, either within certain families or in communities. The volumes in question are 20 liters for setting an order of magnitude.

To produce containers that have adequate rigidity for handling, these containers are produced in the form of thick-walled polycarbonate flasks. The selection of material and the significant thickness of the wall make them very resistant mechanically, which proves necessary for the use to which they are put and the types of handling that they undergo.

These containers can be manipulated easily based on their rigidity, when they are full, but the empty container has a significant weight.

Taking into account the weight that makes such a container impossible to handle for delivering small amounts and for filling a glass, for example, they are used in combination with distributing equipment for delivering the liquid that is contained.

Such equipment, well known under the name of water fountains, comprises a base that is designed to receive the collar and the neck of the container, a container that is installed with the neck at the bottom. This base ensures the mechanical holding of the container and the fluid connection.

The neck of the container is equipped with a ball plug, for example, to connect to a head. This head is connected to the distribution means that comprise at least one distributing spigot.

In certain distributing equipment, at least one additional circuit is provided that is designed to heat or to cool the water after it has been drawn off from the container, whereby the container itself is still at ambient temperature, just like the water that it contains.

These containers are expensive to manufacture, taking into account their high material weight as well as the production process so as to make it possible for them to be packaged several times. In contrast, they can be reused, but this involves numerous constraints.

One constraint is the optional organization of a delivery circuit of full containers but primarily a circuit for picking up empty containers.

Another constraint is the management of the stocks of these empty containers in addition to the management of the full containers, which is basically necessary and obligatory. It is noted that the users also have to manage the empty containers while awaiting their pick-up in addition to full containers.

The empty containers should then be prepared with a withdrawal of the used plug, and then washed, sterilized on site before filling, which can exhibit significant risks, whereby their prior use has not been monitored.

This is not satisfactory in terms of sanitation because the cleaning treatment is complex and necessarily produces a significant level of container loss.

To fill the container with mineral water, it is necessary to fill the container, regardless of the process used, and put a new plug in.

These constraints already lead to significant costs, knowing that at the end of the service life or in the case of degradation, it is necessary to destroy and/or to recycle these polycarbonate containers that have become unusable.

Whereby the containers are directly exposed to the distributing equipment, it is advisable that they remain aesthetically presentable, which requires either delicate handling or frequent renewals.

Another constraint results from the use that is made of these containers, in particular in the case of a distribution with a low flow rate, which spreads the period of use of the contents of the container over several days.

Actually, whereby the containers are rigid, when there is a sampling of water, an intake of air occurs to compensate for the sampled volume.

Thus, the compensating ambient air is introduced by bubbling-through when passing through the liquid volume that remains in the container with all of the microorganisms that it transports, and this air remains in contact with the water during the entire consumption period. This amount of air increases as sampling proceeds.

This is not very satisfactory in terms of sanitation because the cleaning treatment is complex, and it necessarily produces a significant level of container loss.

One solution would consist in using a disposable container, of pocket type, but a pocket of such volume, 20 liters for example, produces certain handling problems.

There are polyethylene containers whose material weight is reduced.

These containers should have, nevertheless, particular shapes; this involves in particular the patent applications WO-03/033361, EP-1468930 and EP-1527999.

Nevertheless, such arrangements are not compatible with large volumes because the thus produced containers cannot be handled except to increase the amounts of material.

The purpose of this invention is to propose a container that can be handled before use: a disposable, thin-walled, high-capacity container with reduced material, designed in particular to contain mineral water.

The purpose of the invention is also the device for receiving and putting into service this container.

The invention is described below, according to one embodiment, by relying on the drawings, drawings in which the different figures show:

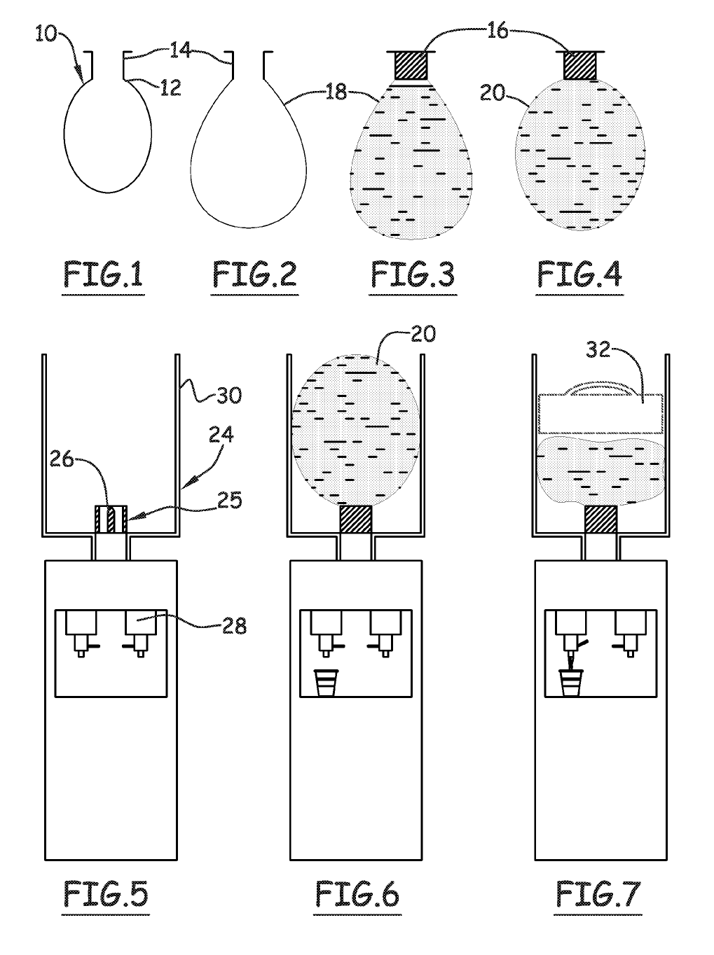

FIGS. 1, 2, 3 and 4: a diagrammatic, synoptic view of the formation of a thin-walled container,

FIGS. 5, 6 and 7: A diagrammatic, synoptic view of a device for receiving and putting into service this container.

The thin-walled container according to the invention, shown in FIGS. 1, 2, 3 and 4, is obtained by hot-shaping or cold-shaping a preformed shape 10 that has a collar 12 and a neck 14 designed to receive a plug 16.

This preformed shape, FIG. 1, is made of a material that can have residual stresses after its shaping to the desired volume.

The process for manufacturing a thin-walled, high-capacity container of more than 2 liters according to the invention comprises the following stages:
Hot-shaping or cold-shaping to the desired volume of a preformed shape 10 that has a collar 12 and a neck 14 designed to receive a plug 16, whereby this preformed shape is able to exhibit residual stresses after its shaping to the desired volume, and
Use of a material weight/developed surface ratio of said container of between 150 g/m² and 250 g/m².

This shaping can be a process for blowing the preformed shape 10 so as to obtain the container 18 at the desired volume, FIG. 2.

For the selection of material, it is preferably possible to resort to PET, polyethylene terephthalate, which is known for its qualities of transparency, low density, conformability, and mechanical strength, but also for its qualities of preservation and low permeability, as well as the presence of residual stresses after shaping to the desired volume.

These containers are packaged under cold conditions and without pressure, in particular for mineral water.

The container 18 is then sealed using a plug 16, preferably a plug that can be pierced, made of elastomer; see FIG. 3.

Also, each container 18 that has thin walls and that has a large volume is difficult to handle immediately after filling. Thus, this container 18, after filling, undergoes a peripheral heating that is designed to release residual stresses that are stored in the material. These released stresses have a tendency to bring the container back to its initial shape before the blowing process, i.e., that of the preformed shape. Because of this tendency toward a reduction of volume of the container and because the liquid that is contained, in this case water, is incompressible, a pressurization of the liquid by the container occurs, which makes this container 20 essentially compact and therefore easy to handle, FIG. 4.

The peripheral heating of the container can be hot-air heating, for example.

Actually, in this case, the wall directly and by itself is subject to the rise in temperature. In addition, the material is not very conductive and absorbs calories. The fluid, in this case water, within the container does not undergo a rise in temperature, taking into account the mass.

The high-capacity containers 20 that are thus obtained can be handled and transported.

In FIGS. 5, 6 and 7, a device 22 for receiving and servicing the container 20 is shown.

This device comprises at least the following elements: a base 24 that is equipped with a sampling means 25, a distribution circuit 28, and receiving means 30 that are designed to receive the container 20, see diagrammatic FIG. 5.

The purpose of the receiving means 30 is to ensure the holding of the container 20 and its guiding so that the plug 16 comes to the right of the sampling means 25, in this case a trocar 26.

Thus, for implementing the device, it is only necessary to place the container 20 with its neck toward the bottom in the receiving means 30.

The essentially rigid container 20 is installed easily.

When this container 20 arrives in the lower part, the plug is pierced by the trocar 26 under the weight of the container 20 itself. This piercing is airtight. Then, the container 18 is non-rigid and cannot be manipulated, but it is held by the receiving means, and this is not a drawback; on the contrary, it becomes an advantage.

Liquid, in this case water, can be sampled from the distribution circuit 28.

Since the inner overpressure is very low, on the order of 0.1 bar, it is immediately evacuated upon the piercing of the plug, leaving the circuit subject to only gravity alone, as in all of these installations.

During sampling, the container empties without thereby requiring the introduction of air. Actually, thanks to the collapsing phenomenon of the container 18, which in this case is an advantage, the volume of sampled liquid is not compensated for, whereby the walls of the container become flattened against one another.

It is even possible to provide a cover 32 that has a certain weight that forms a pig mould, for example two kilos, whereby this cover is free in translation so as to exert a certain pressure on the container 18 during its service life. Once the container 18 is empty, after removing the possible cover/pig mould, it is only necessary to exert traction on said container so as to remove it, whereby the elastomer plug ensures automatic covering of the opening that is created by the trocar.

The disposable container 18 is placed with the other packages that are to be recycled.

This container, when it is empty, can be assimilated into a pocket and therefore occupies only very little space, and primarily its volume is very small, without possible comparison with the volume that it initially occupied when it was full.

The user does not manage any empty container.

The user installs a new container 20 that can be handled in place.

The disposable, thin-walled container 18, 20, according to this invention, is particularly advantageous, and it is used with the receiving and servicing device according to the invention.

It is noted that it is possible to develop specific water fountain devices since the designs and the arrangements can have very free expression. Nevertheless, it is noted that the existing water fountain device can be modified and equipped with a base 24 with a trocar 26 and means 30 for receiving and servicing.

Thus, according to the invention, the process for the production of a container according to the invention makes it possible to solve the handling problems relative to containers of high volume, more than 2 liters, while preserving a thin wall and a very advantageous ratio between the material weight and the developed surface of said container.

Another advantageous feature of the process according to the invention is that it uses existing installations for the production of containers, whereby the modifications of stations are reduced and less burdensome.

The high-volume, thin-walled containers that are also obtained offer numerous prospective applications that are not being considered currently because of cost, weight, and circuits that are necessary for refilling.

Finally, due to the fact of the elimination of the return of packages, it is entirely conceivable to simplify the logistics, whereby the user can supply himself directly from a distributor, managing his stocks himself based on his consumption.

The description has been produced by using a trocar combined with an elastomer plug, but any other analogous sampling means can be used.

1. Process for manufacturing a thin-walled, high-capacity container of more than 2 liters, comprising the following stages:
Hot-shaping or cold-shaping to the desired volume of a preformed shape (10) that has a collar (12) and a neck (14) designed to receive a plug (16), whereby this preformed shape is able to exhibit residual stresses after its shaping to the desired volume,
Use of a material weight/developed surface ratio of said container of between 150 g/m² and 250 g/m², and more particularly between 150 g/m² and 200 g/m².

2. Process for manufacturing a high-capacity container according to claim 1, wherein the material is PET, polyethylene terephthalate.

3. Process for manufacturing a high-capacity container according to claim 1, wherein said container undergoes a heating stage after filling and sealing so as to make it easy to handle.

4. Thin-walled, high-capacity container (20) of more than 2 liters, obtained by the process according to claim 1, wherein it comprises a plug (16) that can be pierced and is made of elastomer.

5. Thin-walled device for receiving and servicing the container (20) according to claim 4, wherein it comprises a base (24) that is equipped with a trocar (26), a distribution circuit (28), and receiving means (30) that are designed to receive said container (20), neck toward the bottom, suitable for ensuring the holding of said container (20) and its guiding so that the plug (16) comes to the right of this trocar (26).
